(19) United States
(12) Patent Application Publication
(10) Pub. No.: US 2006/0008774 A1
(43) Pub. Date: Jan. 12, 2006

(54) Method of producing a dental prosthetic item

(76) Inventors: Ulrich Orth, Lautertal (DE); Volker Wedler, Hirschberg (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/175,306

(22) Filed: Jul. 7, 2005

(30) Foreign Application Priority Data
Jul. 8, 2004 (DE) 10 2004 033 248.7

(51) Int. Cl. A61C 13/08

(52) U.S. Cl. 433/202.1

(57) ABSTRACT

A method of producing a dental prosthetic item from a blank involving generation of a machining schedule for machining equipment includes the following steps: the blank exhibits at least two regions having different properties, the regions are displayed separately together with a reproduction of the prosthetic item, the position of the reproduction of the prosthetic item in the blank can be changed relatively to the regions by input means, and the machining schedule is adjusted or generated taking into consideration the position of the reproduction of the prosthetic item. In this way the position, within the blank, of the prosthetic item to be carved from the blank can be checked and adjusted.

### FIELD OF THE INVENTION

The invention relates to a method of producing a dental prosthetic item from a blank involving the generation of a machining schedule for machining equipment, and to a device for producing a dental prosthetic item.

### DESCRIPTION OF THE RELATED ART

The prior art reveals how to produce dental prosthetic items from ceramic blanks by machining. This is done either by copy-grinding from a positive model, scanning a model or directly scanning a tooth and generating a digital data set followed by designing the dental prosthetic item and producing it with the aid of known CAD/CAM methods.

The dental prosthetic item is embedded in this blank such that, depending on the blank being machined, there are sufficient safe margins relative to the boundaries of the blank. Moreover, the dental prosthetic item can be positioned within the blank automatically during computation of the machining schedule for the machining equipment so as to reduce the volume that must be machined in comparison with a perfectly centered configuration. This is done automatically and without any possibility of operator intervention.

The object of the invention is to provide greater freedom in designing the dental prosthetic item.

### SUMMARY AND OBJECTS OF THE INVENTION

The method of the invention for producing a dental prosthetic item from a blank involving the generation of a machining schedule for machining equipment is construed such that the blank comprises at least two regions having different characteristics, that the regions are separately displayed together with a reproduction of the dental prosthetic item, that for the purpose of adjusting the position, within the blank, of the prosthetic item to be carved from the blank, the position of the reproduction of the prosthetic item in the blank relative to the regions can be changed with the aid of input means and that the machining schedule is adjusted or generated taking into consideration the position of the reproduction of the dental prosthetic item.

The advantage of this method is that a visual inspection of the position is possible, and that the characteristics of the dental prosthetic item can be influenced according to the configuration of the blank.

Instead of, or in addition to, linear displacement, the position may be adjusted by changing the rotational position of the reproduction of the prosthetic item within the blank.

Automatic positioning of the reproduction of the prosthetic item may alternatively be effected on the basis of information from an object into which the dental prosthetic item is to be inserted. This proposal can then be displayed and the position altered accordingly, or provision can be made for the position not to be alterable thereafter.

It is advantageous when at least the abutting boundaries of the regions are displayed. In this way, it is possible to see how the prosthetic item is distributed over the regions.

It is advantageous when the reproduction of the prosthetic item is in the form of a diagram, a contour, a sectional model, part of a 3D surface, a side view, or a silhouette.

The blank and the prosthetic item can be represented in three-dimensional central perspective, the blank preferably being shown as delimited by its outer surfaces and/or as a semitransparent object. The 3D representation creates an especially plastic impression.

Advantage is also gained when the reproduction of the dental prosthetic item is represented in a subregion located in a first region of the blank separately from a subregion located in a second region of the blank, in that the characteristics of the prosthetic item can be easily recognized, and it is possible to check whether the boundary regions run according to requirements.

When the change of position of the prosthetic item is restricted by the outside dimensions of the blank, there is assurance that the prosthetic item can be carved with the desired contours.

When the change of position of the prosthetic item is limited by production-related parameters, particularly the maximum advance increment of the tool, there is likewise assurance that the prosthetic item comprises no unwanted non-machined regions.

According to a development of the invention, a calorimetric measurement is performed in the restoration area of the prosthetic item to be produced, and, based on this calorimetric measurement, a blank comprising differently colored regions is automatically preselected from a large variety of different blanks. This colorimetric measurement can be performed by, eg, measuring the brightness or color hue of dental regions in digital photographic images captured using a conventional intraoral camera. In order to localize these regions in the digital images, the user can mark these regions by means of mouse-clicks or by drawing a line around them, for example.

It is advantageous when, based on the calorimetric measurement, the reproduction of the prosthetic item is automatically positioned within the blank comprising differently colored regions. Deviations in brightness or color can be minimized by comparing the measured values for brightness or hue in the original teeth with the corresponding brightness or hue values in a data-dependent description of the blank.

In principle, information other than color, eg, the restoration shape in the case of blanks showing different degrees of mechanical stability, can be implemented for automatic preselection.

It is advantageous when the position of the reproduction of the prosthetic item can also be subsequently modified in order to make manual adjustments to the default setting.

Possible displacement of the prosthetic item within the blank can depend on the configuration of the regions having different characteristics in the blank. Thus the direction of change of position can be prescribed in advance.

According to another development of the invention, the characteristics of the regions are selected from the properties color, rigidity, material density, translucence, porosity, or a combination thereof. In this manner, it is possible for particular characteristics to be provided in particular subregions of the prosthetic item. All of these characteristics can be used for automatic preselection.

It is advantageous when a default reproduction of a prosthetic item that is to be produced is presented from the labial direction for anterior teeth, and from the buccal direction for the other teeth.

Another aspect of the invention relates to a device for producing a dental prosthetic item from a blank involving generation of a machining schedule for machining equipment. The blank to be processed comprises at least two regions having different characteristics, and means are provided for representing the regions together with a reproduction of the prosthetic item in the form of a diagram, a contour, a sectional model, part of a surface, a side view, or a silhouette. Input means are also provided, with the aid of which it is possible to alter the position of the reproduction of the prosthetic item in the blank relative to said regions, as well as means for adjusting or generating the machining schedule with respect to the position of the reproduction of the prosthetic item.

### BRIEF DESCRIPTION OF THE DRAWINGS

The method of the invention will now be described with reference to the drawings, in which

FIG. 1 is an illustration of a triple-layered blank showing a dental prosthetic item which is to be fashioned from the blank in a central position,

FIG. 2 shows the blank illustrated in FIG. 1, with a prosthetic item shifted in one direction,

FIG. 3 shows the blank illustrated in FIGS. 1 and 2 showing a prosthetic item shifted in a direction opposite that of FIG. 2,

FIG. 4 shows the blank illustrated in FIG. 1 together with a prosthetic item for the anterior teeth region,

FIG. 5 shows a device with its essential components,

FIG. 6 shows a multi-layer blank fastened to a retainer, and

FIGS. 7a-7c illustrate the utilization of a color profile for selection of the blank and configuring the prosthetic item.

### DETAILED DESCRIPTION OF EXEMPLARY EMBODIMENT(S) OF THE INVENTION

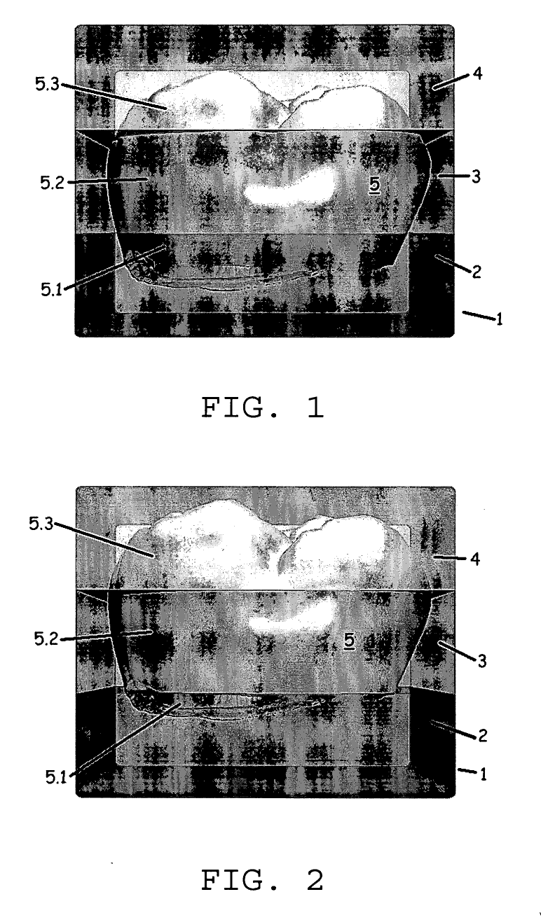

FIG. 1 represents a central perspective view of the outer contour of a blank 1 with three differently colored, semitransparent regions 2, 3, 4. A boundary surface is apparent between regions 3 and 4, for example.

Disposed within blank 1 is a prosthetic item 5 of a molar, which is shown from the buccal direction. Prosthetic item 5 is represented as a 3D surface model in such a way that it is apparent in which of the region 2 to 4 of blank 1 the subregions 5.1 to 5.3 of the prosthetic item are positioned. In the exemplifying embodiment, region 2 is darker than region 3, which is in turn darker than region 4, and therefore the prosthetic item is shown as darker in subregion 5.1 than in subregion 5.2 or subregion 5.3.

The color display in regions 2 to 4 and subregions 5.1 to 5.3 respectively gives information about the course of the regional boundaries on prosthetic item 5, for instance for the purpose of representing a blank having regions of varying coloration or varying material characteristics such as rigidity.

It is not necessary for the displayed representation to reproduce a realistic image showing realistic colors, since human tissue can only be represented with the aid of very elaborate graphic patterns. Here, the information on the position of the prosthetic item within the blank is of primary importance, not the resulting natural reproduction of the color gradient.

FIG. 2 illustrates how the prosthetic item 5 has been pushed into region 4 within the blank, thus enlarging subregion 5.3 and reducing subregion 5.1. As a result, the boundary between regions 3 and 4 has moved further down on prosthetic item 5. The outer boundary of blank 1 limits the degree of displacement in accordance with the maintenance of a safety margin.

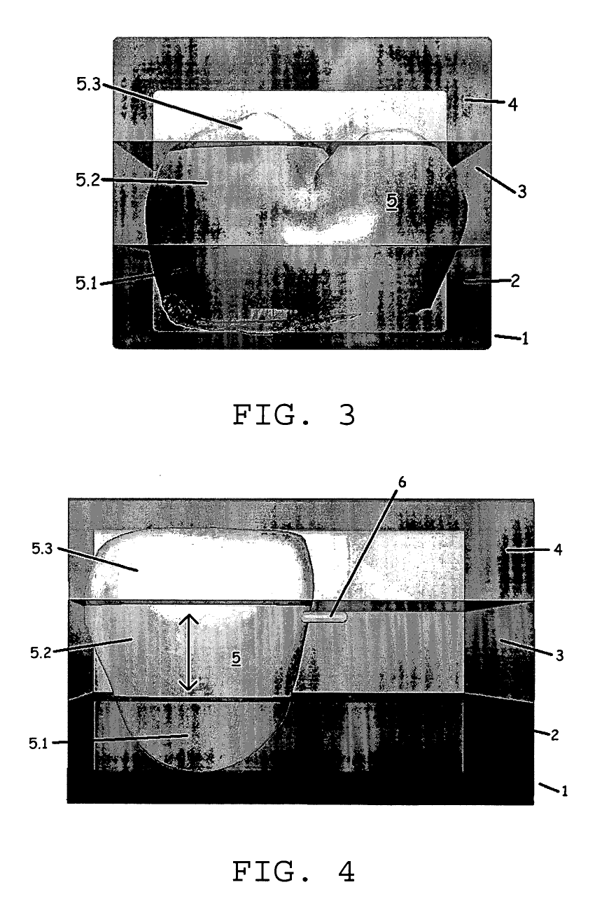

In FIG. 3, prosthetic item 5 is so displaced within blank 1 that there is no longer a subregion of prosthetic item 5 located in region 4, but rather, the prosthetic item 5 is configured with its subregions 5.2, 5.1 in regions 2 and 3 exclusively. Care has been taken not to leave the outer contour of blank 1 in the downward direction.

If inputs dictating further displacement in this direction are nevertheless entered, they are ignored, and an alarm signal is emitted. This also occurs when the machining range of the tool is exceeded, so that the ability to produce the prosthetic item will always be guaranteed.

FIG. 4 shows the reproduction of a prosthetic item 5 to replace an anterior tooth, as seen from the labial direction. The prosthetic item 5 extends across regions 2, 3, 4 and is displaceable upwardly and downwardly in the direction of the arrows. The relationship of subregions 5.1, 5.2, 5.3 to one another can be changed in this manner.

Provided on the prosthetic item 5 is a connector 6 which represents the connection of the prosthetic item carved from blank 1 to a remaining region of the blank. This connector 6 is freely displaceable along the prosthetic item 5 within the limits of the machining range. The machining schedule is adapted to the changed position of the prosthetic item within the blank 1 and to the changed position of connector 6. The same applies to the prosthetic item shown in FIGS. 1 to 4.

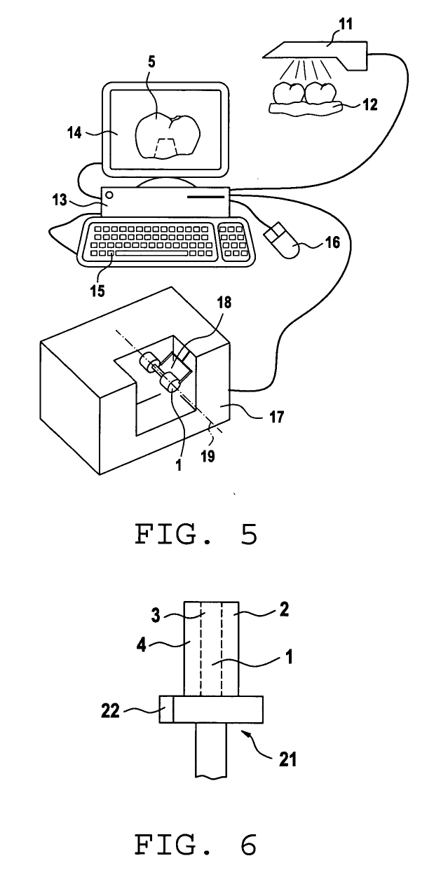

FIG. 5 is a diagrammatic representation of a device for carrying out the method according to CAD/CAM principles. A model 12 of a dental restoration region is scanned with the aid of a scanning device 11, and a three-dimensional data set of the dental prosthetic item 5 to be produced is created on the basis of the scanned data. This occurs on a computer 13 comprising a display unit 14 and input means in the form of a keyboard 15 or a mouse 16. Other input means such as a graphic tablet can also be used for performing said construction. A camera can also be provided for measuring the color of the preparation area.

The prosthetic item 5 designed on the display unit 14 is produced from a blank 1 in a machining unit 17 by the removal of material from the blank 1 by means of a machining tool 18. In order to be able to carry out the method, the position of blank 1 relative to a machining axis 19 of the machining unit 17 must be known in case the blank will be rotated about said axis during the machining operation. If this is not the case, it is enough to know the position of blank 1 relative to tool 18.

The advance increment of machining tool 18 is inherently limited, so that only a certain amount of machining space is available. This machining space, as well as the outer boundary of blank 1 itself, must be taken into account when creating the machining schedule for the production of the prosthetic item from the blank.

FIG. 6 illustrates a blank 1 attached to a retainer 21, which blank is clamped into the machining equipment 17 by means of retainer 21 and positioned over a centering hole 22. The position of the blank on the retainer is known within a certain tolerance, as is the position of the blank in the processing machine 17. The position of machining tool 18 relative to blank 1 is also known, and consequently the configuration of regions 2, 3, 4 relative to one another and to blank 5 is also known.

A displacement in the direction of the layering is provided in the layered blank represented in FIG. 1 to 4. With blanks having a more complex geometry of the individual regions, other directions of displacement can be provided within the six degrees of freedom of displacement or rotation.

In practice, the image displayed is a stylized color representation with color boundaries, though a plain black-and-white representation is sufficient for visualization. Nor is it absolutely necessary to choose the 3D representation shown here. Rather, a two-dimensional view of a silhouette of the tooth from the buccal or labial direction, for example, is sufficient.

Furthermore, the block boundaries need not be visible for visualization purposes, although this is helpful for representing the limits of displacement.

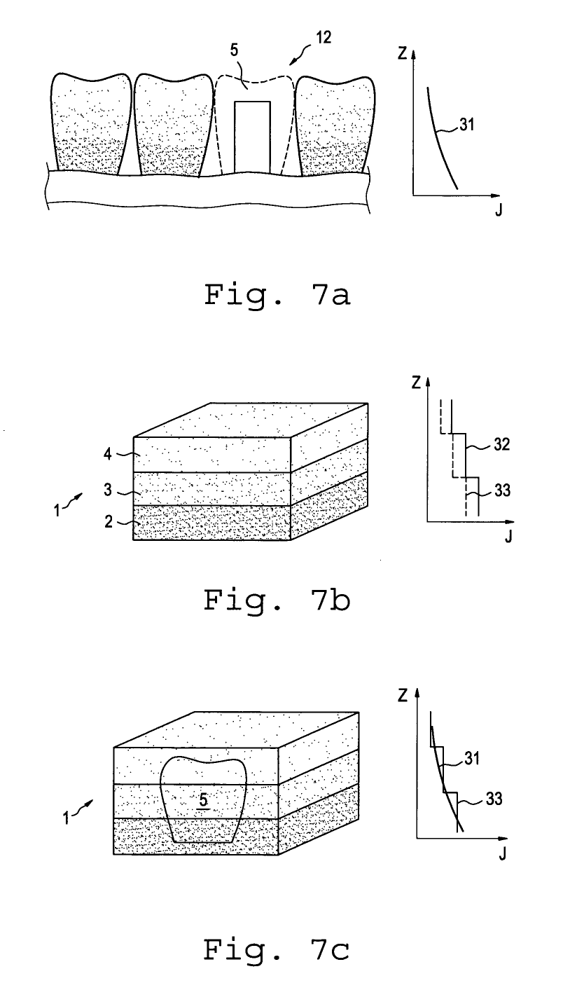

FIG. 7a illustrates the preparation area 12 in the anterior teeth region in detail, where the prosthetic item 5 to be created will fit between two existing adjacent teeth in conformance with their shape and color. To this end, the preparation area 12 is scanned in order to generate a 3D data set, and the color profile 31 of the adjacent teeth is determined. The color profile is specified in a coordinate system having a height coordinate Z and a color saturation coordinate J.

FIG. 7b illustrates blank 1 having three superimposed layered regions 2, 3, 4.

Two curves 32, 33 for two different blanks are shown in the coordinate system depicting color saturation gradients. Other gradients are, of course, feasible, for instance the combination of a very bright region 4 with a very dark region 2.

FIG. 7c illustrates, with reference to the color saturation diagram, how the saturation gradient measured in the region of the preparation site compares with the color saturation gradient 33 of a blank (not shown). Known statistical methods are suitable for this purpose, for instance the technique of minimizing the square of the deviations.

In addition to selecting a blank having the most closely resembling color saturation gradient, automatic positioning of prosthetic item 5 within blank 1 is performed taking into consideration the outer boundaries of the blank.

Gradients of translucence, material strength, porosity, or some other property can alternatively be utilized instead of, or in addition to, the color saturation values.

1. A method of producing a dental prosthetic item from a blank involving the generation of a machining schedule for machining equipment, wherein
said blank exhibits at least two regions having different properties,
said regions are displayed separately together with a reproduction of said prosthetic item,
for the purpose of adjusting the position, within blank, of said prosthetic item to be carved from said blank, the position of said reproduction of said prosthetic item in said blank can be changed relatively to said regions, and
said machining schedule is adjusted or generated taking into consideration the position of said reproduction of said prosthetic item.

2. A method as defined in claim 1, wherein at least the abutting boundaries of said regions are displayed.

3. A method as defined in claim 1 or claim 2, wherein said reproduction of said prosthetic item is displayed as a diagram, a contour, a sectional model, part of a surface, a side view, or a silhouette.

4. A method as defined in claim 1, wherein said blank and said prosthetic item are displayed in a three-dimensional central perspective, said blank being delimited by its external surfaces and is also displayed semitransparently.

5. A method as defined in claim 4, wherein said reproduction of said prosthetic item is displayed in a subregion, which is disposed in a first region of said blank, separately from a subregion disposed in a second area of said blank.

6. A method as defined in claim 1, wherein the change of position of said prosthetic item is restricted by the exterior dimensions of said blank.

7. A method as defined in any one of claims 1 claim 1, wherein the change of position of said prosthetic item is restricted by production-related fabrication parameters, particularly the maximum advance increment of a machining tool.

8. A method as defined in claim 1, wherein colorimetric measuring is carried out in the restoration area of said prosthetic item to be fabricated and that a blank having differently colored regions is automatically selected from a large number of different blanks in conformance with said calorimetric measurement.

9. A method as defined in claim 8, wherein with reference to said calorimetric measurement, said reproduction of said prosthetic item is automatically positioned within said blank having differently colored regions.

10. A method as defined in claim 9, wherein the adjusted position of said reproduction of said prosthetic item can be subsequently changed.

11. A method as defined in claim 1, wherein any shift of said prosthetic item within said blank is dependent on the arrangement of said regions within said blank.

12. A method as defined in claim 1, wherein the properties of said regions are selected from the group consisting of the properties rigidity, material density, translucence, or porosity, or a combination of two or more of said properties.

13. A method as defined in claim 1, wherein a default setting displays the anterior teeth region from the labial direction and the other teeth from the buccal direction.

14. A method of producing a dental prosthetic item from a blank involving the generation of a machining schedule for machining equipment, wherein
said blank exhibits at least two regions having different properties,
means are provided for the display of said regions together with a re-production of said prosthetic item, which reproduction is particularly in the form of a diagram, a contour, a sectional model, part of a surface, a side view, or a silhouette,
input means are provided for changing the position of said prosthetic item within blank relative to said regions and
means are provided for adjusting or generating said machining schedule taking into consideration the position of said reproduction of said prosthetic item.
